(19) United States
(12) Patent Application Publication
(10) Pub. No.: US 2026/0168304 A1
(43) Pub. Date: Jun. 18, 2026

(54) METHOD FOR DETECTING AN OBSTRUCTION OF AN AUTOMATIC DOOR SYSTEM AS WELL AS A DETECTION UNIT

(71) Applicant: Assa Abloy Entrance System AB, Landskrona (SE)

(72) Inventors: Emanuel PONGRATZ, Lippstadt (DE); Konstantin SCHMIDT, Erwitte (DE); Anders STENING, Lippstadt (DE)

(21) Appl. No.: 19/123,550

(22) PCT Filed: Nov. 9, 2023
(86) PCT No.: PCT/EP2023/081249

§ 371 Date: Apr. 23, 2025

(30) Foreign Application Priority Data
Nov. 15, 2022 (SE) 2230368-9

(51) Int. Cl. E05F 15/43; E05F 15/48; E05F 15/73; E05F 15/74; E05F 15/75

(52) U.S. Cl. CPC E05F 15/43; E05F 15/48; E05F 15/74; E05F 15/75; E05F 2015/436; E05F 2015/765; E05Y 2400/44; E05Y 2400/552; E05Y 2900/132

(57) ABSTRACT

A method for detecting an obstruction of a door (18) of an automatic door system (12) is provided. The automatic door system (12) comprises a door (18), at least one sensor (26), and a control unit (22) configured to control the motion of the door (18). The method comprises the following steps:
a. receiving information about or determining when the door (18) is in its open state,
b. after a predetermined hold open time has elapsed and if the door (18) cannot be closed, determining that the door (18) has been obstructed, and
c. outputting a signal indicating that the door (18) is obstructed.

Further, a detection unit (14) for an automatic door system (12), a system (10) as well as a computer program product are provided.

The invention relates to a method for detecting an obstruction of a door of an automatic door system, a detection unit for an automatic door system, a system with an automatic door system as well as a computer program product.

Automatic door systems are used to isolate different areas from another, for example thermally isolate an indoor area from an outdoor area. Further, different production areas within the same building may be isolated from one another in order to avoid cross-contamination (e.g. in food production) or to avoid contamination at all (e.g. of a clean room).

Thus, the doors of such automatic door systems should be in their close state for as long as possible, i.e. as long as no user needs to pass the passageway of the door system.

However, doors of automatic door systems may be obstructed, either accidentally by items or goods lost in the passageway of the door, or even on purpose by users who need to pass the door frequently and want to avoid waiting for the door to be opened every time they need to pass the door.

These obstructions, however, reduce the effect of the door and need to be detected quickly.

It is therefore an object of the invention to provide a method, a detection unit, a system and a computer program product to detect an obstruction of the door automatically.

For this purpose, a method for detection an obstruction of a door of an automatic door system is provided. The automatic door system comprises a door, at least one sensor, and a control unit configured to control the motion of the door. The method comprises the following steps:
a. receiving information about or determining when the door is in its open state,
b. after a predetermined hold open time has elapsed and if the door cannot be closed, determining that the door has been obstructed, and
c. outputting a signal indicating that the door is obstructed.

By using a predetermined hold open time, a determination whether the door is obstructed or not can be achieved, as it is very unlikely that a door is kept open longer than the predetermined hold open time when the door is not obstructed.

The predetermined hold open time is, for example, starting when the door has reached its open state.

The predetermined hold open time is, for example, based on the type of door, the average or expected usage of the door, the types of items, vehicles or goods that need to pass the door or are expected to pass the door. The predetermined hold open time is, for example, 10 seconds.

For safe operation of the door, the method may comprise the following further steps:
a. after the predetermined hold open time has elapsed, performing a safety check checking for input of the at least one sensor indicating that the door cannot be closed safely, and
b. if the safety check yields no input indicating that the door cannot be closed safely, closing the door.

In an embodiment, the method comprises the following further steps:
a. after the predetermined hold open time has elapsed, performing a safety check checking for input of the at least one sensor indicating that the door cannot be closed safely,
b. if the safety check yields an input indicating that the door cannot be closed safely, determining whether the input has been of the same sensor as an input that has led to opening of the door or to keeping the door open, and
c. if the input has been of the same sensor, determining that the door has been obstructed.

By requiring that the same sensor has been responsible for opening the door or keeping the door open and preventing a closing of the door, the accuracy of the detection of obstructions is improved.

This may be illustrated by the following exemplary reasoning. The object that had triggered the sensor to generate the respective input to the control unit the first time should—under normal circumstances—not be close to or in the passageway of the door after the predetermined hold open time has elapsed, as the predetermined hold open time allows sufficient time for a passage through the door. Thus, this sensor should not be triggered by the object again. However, if it is the same sensor generating the respective input to the control unit also a consecutive, second time, the object or manipulation that triggers the sensor is highly likely to be permanent, meaning that the door is obstructed.

If the input has not been of the same sensor, it is determined that the door is not obstructed or another requirement is checked, which may lead to a determination that the door is obstructed.

In an aspect, the method comprises the following further steps:
a. after the predetermined hold open time has elapsed, performing a safety check checking for input of the at least one sensor indicating that the door cannot be closed safely,
b. if the safety check yields an input indicating that the door cannot be closed safely, determining whether the input has been present continuously for a predetermined confirmation time, and
c. if the input has been present continuously for the predetermined confirmation time, determining that the door has been obstructed.

Continuously is to be understood with respect to the sampling rate of the respective sensor or the frequency at which an updated input is sent.

The predetermined confirmation time may be the same as, longer or shorter than the predetermined hold open time.

Checking whether the relevant input has been continuously present further improves the accuracy of the obstruction detection.

If the input has not been continuously, it is determined that the door is not obstructed or another requirement is checked, which may lead to a determination that the door is obstructed.

Further, it is conceivable that it is determined that the door is obstructed only if both requirement, i.e. that the input has been of the same sensor and that the input has been present continuously for the predetermined confirmation time, are fulfilled at the same time.

The case that the input has been present continuously may include the case that the input at the lapse of the predetermined hold open time is of the same sensor as the input leading to opening of the door or to keeping the door open.

For reliable and safe operation, the control unit receives an input from the at least one sensor indicating a presence of an object close to or in the passageway of the door and/or indicating a command to open the door, and the control unit opens the door or keeps the door open due to the reception of the input.

It may be this input (rather the corresponding sensor) that is compared to the sensor corresponding to the input at the time of the safety check to determine whether the sensors are the same allowing to detect an obstruction as described above.

The control unit may control an actuator of the automatic door system that in turn actuates the door.

The at least one sensor may be configured to monitor the passageway of the door, further increasing safety.

For example, the at least one sensor is a photocell, an infrared sensor, a laser scanner, a light curtain, a radar, an electromechanical contact sensor, in particular an electromechanical safety edge, a button, a switch, in particular an emergency stop switch, a lever, in particular an emergency brake release lever, and/or an interface for receiving a signal indicating the open or closed state of another door, providing reliable inputs.

In another embodiment, if, after the predetermined hold open time has elapsed and the door is being closed, an input of a sensor is received during the closing movement of the door, and the input of the sensor leads to a stop or a reopening of the door, the predetermined hold open time is still regarded as having elapsed. This way, the time before an obstruction may be detected may be decreased.

For reliably detecting obstruction in these cases, if an input of the same sensor, in particular of an electromechanical contact sensor, is received during consecutive closing movements for a predefined number of times greater than one, it is determined that the door is obstructed.

The predetermined number may be greater than 1, in particular greater than 3, for example 5.

In an embodiment, the status whether the door is in its open or closed state, the lapse of the predetermined open time, the sensor inputs and/or the result of the safety check are transmitted to a detection unit, in particular by the control unit, wherein the detection unit determines whether the door is obstructed. This way, the control unit does not need to provide the resources for determining an obstruction.

For example, wherein the detection unit is part of the control unit, resulting in a compact system, or is separate from the control unit allowing greater flexibility.

For providing a central analysis, the detection unit may be a server located remote from the automatic door system.

In an embodiment, if it has been determined that the door is obstructed, at least one of the following measures is taken by the control unit and/or the detection unit:
a warning is outputted at the door, in particular the warning being an acoustic warning and/or a visual warning,
a notification is sent to a supervisor of the owner of the door system,
a visual indication is displayed in a control interface for the automatic door system,
a maintenance instruction is sent to a technician of the owner or the manufacturer of the door system, and/or
a notification is sent to the manufacturer of the door system.

This way, the obstruction can be quickly removed to restore the full isolation functionality of the door.

The control interface may be a web interface, in particular of a cloud system. The cloud system may include information about a plurality of automatic door systems.

For above mentioned purpose, a detection unit for an automatic door system is further provided, wherein the detection unit is configured to carry out a method as described above.

The features and advantages described with respect to the method also apply to the detection unit and vice versa.

Further for above mentioned purpose, a system is provided having an automatic door system comprising a door, at least one sensor, and a control unit configured to control the motion of the door, as well as a detection unit, in particular a detection unit as described above, wherein the system is configured to carry out a method as described above.

The features and advantages described with respect to the method and/or the detection unit also apply to the system and vice versa.

Further, a computer program product is provided, the computer program product being embodied on a computer readable storage medium and configured so as when executed on a processor to perform operations of the method as described above.

The features and advantages described with respect to the method, the detection unit and/or the system also apply to the computer program product and vice versa.

Further features and advantages will be apparent from the following description as well as the accompanying drawings, to which reference is made. In the drawings:

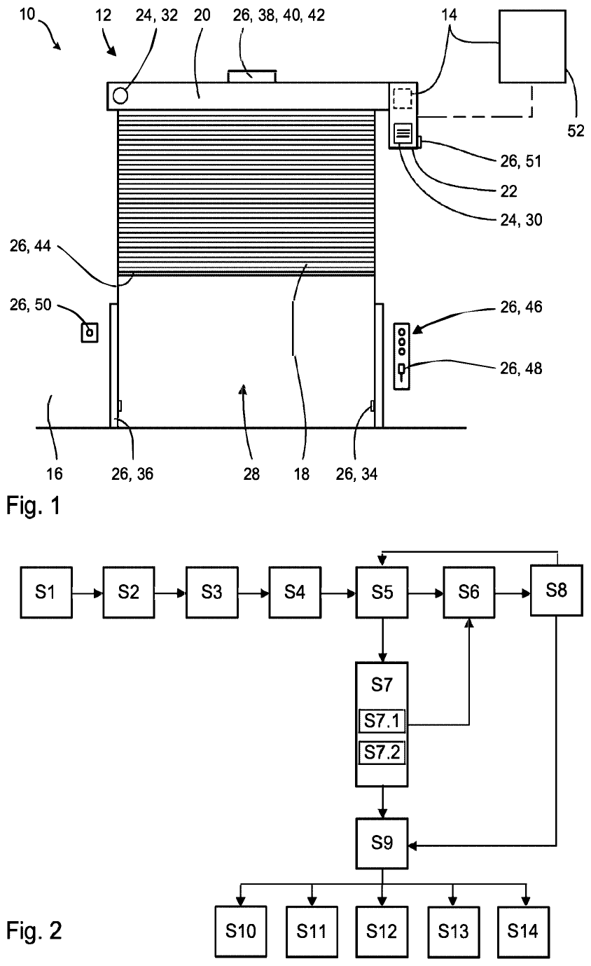

FIG. 1 shows a system according to an embodiment of the invention with an automatic door system and a detection unit according to an embodiment of the invention in a schematic view, and

FIG. 2 shows a flowchart of a method according to an embodiment of the invention.

FIG. 1 shows a system 10 having an automatic door system 12 as well as a detection unit 14.

In the shown embodiment, the automatic door system 12 is located in a building wall 16 to allow access into the building. It is also conceivable that the automatic door system 12 is located in an interior wall 16 to provide separation between different areas within the building itself, for example different production areas to avoid cross-contamination.

The automatic door system 12 is, in the shown embodiment, a high-speed door system having a door 18, an actuator 20, a control unit 22, output means 24 as well as at least one sensor 26.

The actuator 20 is located above the passageway 28 and capable of rolling the door 18 up and down. In the open state of the door 18, the door 18 is rolled up and the passageway 28 is cleared. In the closed state of the door 18, the door 18 is roll down and the passageway is closed.

The control unit 22 is connected to the actuator 20 and configured to control the actuator 20 so that—by means of the actuator 20—the control unit 22 is configured to control the motion of the door 18 itself.

The output means 24 are also connected to the control unit 22 and configured to be controlled by the control unit 22.

In the shown embodiment, the output means 24 comprise a speaker 34 designed for outputting an acoustic warning and a light 32, in particular a strobe light, designed for outputting a visual warning.

The automatic door system 12 comprises a plurality of sensors 26 connected to the control unit 22, wherein each of the sensors is configured to monitor the passageway 28 of the door 18 with respect to objects, e.g. persons, vehicles or goods, possibly being located in the passageway 28 and/or is configured to indicate a manual stop command/or activation command to the control unit 22.

In the shown embodiment, the automatic door system 12 comprises as sensors 26 a photocell 34 and a light curtain 36 located at the bottom of the passageway 28 at either side of the passageway 28.

Further, in the shown embodiment the automatic door system 12 comprises as sensors 26 an infrared sensor 38, a laser scanner 40 and/or a radar 42 located above the passageway 28, in particular above the actuator 20, and having a field of view downwards at the passageway 28 and in front of the passageway 28 and/or at the back of the passageway 28 to detect oncoming objects. It is also conceivable that an infrared sensor, a laser scanner and/or a radar is located below (i.e. in the floor) and/or in the region of the lower half of the passageway 28, having a field of view upwards at the passageway 28 as well as in front of the passageway 28 and/or at the back of the passageway 28.

Further, the door 18, in particular the lower edge of the door 18, is provided with an electromechanical contact sensor 44, namely an electromechanical safety edge, as one of the sensors 26.

All of the above mentioned sensors are configured to monitor the passageway 28 of the door 18 with respect to objects in the passageway 28 and/or close to the passageway 28.

To receive manual commands from users, e.g. a command to open or stop the door 18, the automatic door system 12 comprises as one of the sensors 26 a plurality of control switches 46, a lever 48, in particular an emergency brake release lever, and/or a button 50, in particular an emergency stop button located sideways of the passageway 28.

An interface 51 of the automatic door system 12 to another automatic door system may also constitute a sensor 26 in the case that the two door systems are interlocked, i.e. that only one door of the two door systems may be in the open state at any given time. In this case, the signal about the open or closed state of the other door systems is the sensor input of the interface 51.

The detection unit 14 may be part of the control unit 22, as indicated in dashed lines in FIG. 1. In the shown embodiment, the detection unit 14 is, however, separate from the control unit 22 and provided as a server 52 remote from the automatic door system 12, in particular a server 52 accessible by the control unit 22 via the Internet.

The detection unit 14 may run as an application on the server 52.

During use of the automatic door system 12, the door 18 may become obstructed, either accidentally or on purpose. For detecting such an obstruction of the door 18, the method as shown in FIG. 2 may be carried out.

In step S1, the control unit 22 receives an input from one of the sensors 26 that an object is close to the passageway 28 or in the passageway 28 of the door, for example an object in the light curtain 36. The input may also be a manual command to open the door 18, for example because one of the control switches 46 has been actuated.

The inputs of the sensors 26 received by the control unit 22 are, for example, also transmitted to the detection unit 14 so that the detection unit 14 also receives inputs of the sensors 26.

In either case, in step S2, the control unit 22 opens the door 18, if the door has been in its closed state or keeps the door open if the door 18 has been in its open state. Further, if the door 18 has been in closing motion, the control unit 22 reopens the door 18.

To this end the control unit 22 controls the actuator 20 to roll up the door 18.

The control unit 22 and/or the detection unit 14 determines, whether the door 18 is in its open state or in its closed state. If the open state or closed state of the door 18 is only determined by the control unit 22, the information about whether the door 18 is in its open state or in its closed state may be transmitted to the detection unit 14.

In step S3, the control unit 22 and/or the detection unit 14 measure how long the door has been held open. The measurement may start when the door 18 has reached its open state.

Further, in the detection unit 14 and/or the control unit 22, a predetermined hold open time is stored. For example, the predetermined hold open time is set during the setup of the automatic door system 12, by the manufacturer or by the owner of the automatic door system 12.

The predetermined hold open time is, for example, based on the type of door 18, the average or expected usage of the door 18, the types of items, vehicles or goods that need to pass the door 18 or are expected to pass the door 18.

For example, the predetermined open time lies in the range of 1 to 99 second, in particular between 5 to 30 seconds, more particularly the predetermined open time is 10 seconds.

In step S4, the control unit 22 and/or the detection unit 14 determine whether the door 18 has been in the open state longer than the predetermined hold open time, i.e. whether the predetermined hold open time has elapsed.

The lapse of the predetermined hold open time may be transmitted to the detection unit 14 if only determined by the control unit 22.

Once the predetermined hold open time has elapsed, the control unit 22 and/or the detection unit 14 performs a safety check in step S5 in order to determine whether it is safe to close the door 18. The result of the safety check may also be transmitted to the detection unit 14 if the safety check is carried out by the control unit 22 only.

For the safety check, the inputs of the sensors 26 are checked for any input indicating that the door 18 cannot be closed safely.

An input indicating that the door 18 cannot be closed safely may be an interrupted light curtain 36 or that the photocell 34 does not receive a signal above a predetermined threshold. It may also be that the infrared sensor 38, the laser scanner 40 and/or the radar 42 indicate objects in or close to the passageway 28. Further, the emergency stop button 50 may be pressed or the like.

If no such input is present at the control unit 22 and/or the detection unit 14 at the time the safety check is performed, it is determined that it is safe to close the door and the control unit 22 closes the door 18 (step S6).

If, however, at the time of the safety check such an input indicating that it is not safe to close the door 18 is present, the door 18 cannot be closed. And it is, in step S7, determined by the control unit 22 and/or the detection unit 14 that the door 18 is obstructed.

For a more precise obstruction detection the control unit 22 and/or the detection unit 14 may, if the safety check yields that the door 18 cannot be closed safely, test a further requirement in step S7.1 and/or in step S7.2.

In step S7.1, it is determined whether the input indicating at the time of the safety check that the door 18 cannot be closed is an input of the same sensor 26 than the input that has led to the opening of the door 18 or to keeping the door 18 open, e.g. the input received in step S1.

If this is not the case, then it is assumed that no obstruction is present and the door 18 can be closed. Step S6 may then be carried out.

If, however, said inputs are of the same sensor 26, then it is determined that the door 18 is obstructed.

For determining that the door 18 is obstructed, the following reasoning is followed, for example. The object that had triggered the sensor 26 to generate the respective input to the control unit 22 the first time should—under normal circumstances—not be close to or in the passageway 28 of the door 18 after the predetermined hold open time has elapsed, as the predetermined hold open time allows sufficient time for a passage through the door 18. However, if it is the same sensor 26 generating the respective input to the control unit 22 also a consecutive, second time, the object or manipulation that triggers the sensor 26 is highly likely to be permanent, meaning that the door 18 is obstructed.

Put differently, the determination that the door 18 is obstructed if the same sensor 26 generates an input indicating that the door 18 cannot be closed safely may be based on the assumption that the situation at the door 18 has not changed for the duration of the predetermined hold open time and therefore will not change in the future.

This reasoning may be illustrated by the following examples: Due to a forklift passing the passageway 28 of the open door 18, the light curtain 36 is triggered so that the light curtain 36 generates a respective input to the control unit 22 indicating that the door 18 cannot be closed. The control unit 22 then waits the predetermined hold open time.

After the predetermined hold open time has elapsed, the forklift has passed door 18 and left the passageway 26, and the control unit 22 performs another safety check. The light curtain 36 does not generate a respective input any more, as the forklift has passed. However, the radar 42 detects an oncoming person and generates a respective input to the control unit 22. Even though the safety check yields an input indicating that the door 18 cannot be closed safely, the door 18 is correctly not regarded as obstructed.

On the other hand, a crate may be present in the passageway 26 of the door 18, e.g. in the light curtain 36. The light curtain 36 is triggered so that the light curtain 36 generates a respective and permanent input to the control unit 22 indicating that the door 18 cannot be closed safely. The control unit 22 then waits the predetermined hold open time.

After the predetermined hold open time has elapsed, the crate is still present in the passageway 26 when the control unit 22 performs another safety check. The control unit 22 receives yet again the respective input from the light curtain 26 due to the presence of the crate. The door 18 is therefore correctly regarded as obstructed.

Alternatively or in addition, another further requirement may be tested in step S7.2. In step S7.2 it may be determined, when the door 18 cannot be closed safely, whether or not the input indicating that the door 18 cannot be closed safely has been present continuously at least for a predetermined confirmation time.

For example, the word “continuously” is to be understood with respect to the sampling rate of the respective sensor 26 and/or the frequency at which an updated input is sent to the control unit 22 and/or detection unit 14. If the consecutive inputs are the same, then the input is regarded as continuous.

In the case that the input that has indicated that the door 18 cannot be closed safely at the time of the safety check has not been continuously present for the predetermined confirmation time, it is determined that the door 18 is not obstructed and the door 18 is closed. Step S6 may then be carried out.

The predetermined confirmation time may be the same as, longer or shorter than the predetermined hold open time.

If, however, the input has been present continuously for the predetermined confirmation time, it is determined that the door 18 is obstructed.

The case that the input has been present continuously includes the case that the input at the lapse of the predetermined hold open time and the input that has led to opening of the door or to keeping the door open in step S1 are of the same sensor, in particular if the predetermined confirmation time is the same or greater than the predetermined hold open time.

It is conceivable, that only one or both of the further requirements of steps S7.1 and S7.2 need to be fulfilled before it is determined that the door 18 is obstructed.

Further, an obstruction may also be detected during closing of the door 18, i.e. after step S6.

If the door is being closed in step S6, and an input of a sensor 26 indicating that the door 18 cannot be closed safely is received during the closing movement of the door, in step S8 the movement of the door 18 is stopped and/or the door 18 is reopened.

The sensor 26 inputting the signal may be in particular the electromagnetic contact sensor 44.

In this case, the predetermined hold open time is still regarded as having elapsed so that another safety check is carried out, i.e. step S5 is repeated.

The door 18 may then be closed again and, yet again, during this consecutive closing movement, an input of one of the sensors 26 is received leading to a stop or reopening of the door 18 (step S8).

If during a predetermined number of consecutive closing movements it is the input of the same sensor 26, in particular of the electromagnetic contact sensor 44, that repeatedly leads to a stop or reopening of the door 18, it is determined in step S9 that the door 18 is obstructed.

The predetermined number of consecutive closing movements is greater than 1, in particular greater than 3, for example 5.

If it has been determined that the door 18 is obstructed (step S7 and/or step S9), then one or more of the following measures may be taken by the control unit 22 and/or the detection unit 14. In particular, the detection unit 14 may instruct the control unit 22 to perform any of the measures.

In step S10, the control unit 22 activates one of the output means 24 to issue a warning at the door, in particular an acoustic warning using the speaker 30 and/or a visual warning using the light 32.

In step S11, a notification may be sent to a supervisor of the owner of the door system 12, for example by the detection unit 14. The notification may be an e-mail, a push notification to a mobile device or a notification in a control interface for the supervisor.

A visual indication may be displayed in a control interface for the automatic door system 12 (Step S12). The control interface may be an interface accessible via the Internet provided by the detection unit 14 or an application on the same server 52 as the detection unit or on a different server.

In step S13, a maintenance instruction may be sent to a technician of the owner or manufacturer of the door system 12, for example a facility manager, by the detection unit 14 and/or the control unit 22.

In step S14 a notification may be sent to the manufacturer of the door system 12, in particular for statistical purposes.

By this method, a reliable way of detecting obstructed doors 18 may be provided. In particular, if the detection unit 14 receives the input of the sensors 26 and receives or determines the open state of the door 18, the detection unit 14 may detect an obstruction on its own. In this case, the control unit 22 does not need to be provided with additional resources for the detection of an obstruction.

In any case, an obstruction of the door 18 may be detected automatically and immediately so that the source of the obstruction (accidental or even on purpose) may be removed. Even if the obstruction has been on purpose by the users of the door 18, informing a supervisor leads to removing of the source of obstruction, as the supervisor may order the users of the door 18 to remove the source of obstruction so that the door 18 can fulfill its purpose.

Thus, the time that door 18 is obstructed is reduced, increasing the time the door 18 fulfills its isolation purpose, for example thermally isolating an indoor area from an outdoor area or separating different production areas.

1. Method for detecting an obstruction of a door (18) of an automatic door system (12), the automatic door system (12) comprising a door (18), at least one sensor (26), and a control unit (22) configured to control the motion of the door (18), wherein the method comprises the following steps:
a. receiving information about or determining when the door (18) is in its open state,
b. after a predetermined hold open time has elapsed and if the door (18) cannot be closed, determining that the door (18) has been obstructed, and
c. outputting a signal indicating that the door (18) is obstructed.

2. Method according to claim 1, characterized by the following further steps:
a. after the predetermined hold open time has elapsed, performing a safety check checking for input of the at least one sensor (26) indicating that the door (18) cannot be closed safely, and
b. if the safety check yields no input indicating that the door (18) cannot be closed safely, closing the door (18).

3. Method according to claim 1, characterized by the following further steps:
a. after the predetermined hold open time has elapsed, performing a safety check checking for input of the at least one sensor (26) indicating that the door (18) cannot be closed safely,
b. if the safety check yields an input indicating that the door (18) cannot be closed safely, determining whether the input has been of the same sensor (26) as an input that has led to opening of the door (18) or to keeping the door (18) open, and
c. if the input has been of the same sensor (26), determining that the door (18) has been obstructed.

4. Method according to claim 1, characterized by the following further steps:
a. after the predetermined hold open time has elapsed, performing a safety check checking for input of the at least one sensor (26) indicating that the door (18) cannot be closed safely,
b. if the safety check yields an input indicating that the door (18) cannot be closed safely, determining whether the input has been present continuously for a predetermined confirmation time, and
c. if the input has been present continuously for the predetermined confirmation time, determining that the door (18) has been obstructed.

5. Method according to claim 1, characterized in that the control unit (22) receives an input from the at least one sensor (26) indicating a presence of an object close to or in a passageway (28) of the door (18) and/or indicating a command to open the door (18), and the control unit opens the door (18) or keeps the door (18) open due to the reception of the input.

6. Method according to claim 1, characterized in that, the at least one sensor (26) is configured to monitor a passageway (28) of the door (18).

7. Method according claim 1, characterized in that the at least one sensor (26) is a photocell (34), an infrared sensor (38), a laser scanner (40), a light curtain (36), a radar (42), an electromechanical contact sensor in particular an electromechanical safety edge, a button (50), a switch (46), in particular an emergency stop switch, a lever (48), in particular an emergency brake release lever, and/or an interface (51) for receiving a signal indicating an open or closed state of another door (18).

8. Method according to claim 1, characterized in that, if, after the predetermined hold open time has elapsed and the door (18) is being closed, an input of a sensor (26) is received during the closing movement of the door (18), and the input of the sensor (26) leads to a stop or a reopening of the door (18), the predetermined hold open time is still regarded as having elapsed.

9. Method according to claim 8, characterized in that, if an input of the same sensor (26), in particular of an electromechanical contact sensor is received during consecutive closing movements for a predefined number of times greater than one, it is determined that the door (18) is obstructed.

10. Method according to claim 1, characterized in that a status whether the door (18) is in its open or closed state, a lapse of the predetermined open time, inputs of the at least one sensor (26) and/or a result of a safety check are transmitted to a detection unit (14), in particular by the control unit (22), wherein the detection unit (14) determines whether the door (18) is obstructed.

11. Method according to claim 10, characterized in that the detection unit (14) is part of the control unit (22) or is separate from the control unit (22).

12. Method according to claim 10, characterized in that the detection unit (14) is a server (52) located remotely from the automatic door system (12).

13. Method according to claim 10, characterized in that, if it has been determined that the door (18) is obstructed, at least one of the following measures is taken by the control unit (22) and/or the detection unit (14):
a warning is outputted at the door (18), in particular the warning being an acoustic warning and/or a visual warning,
a notification is sent to a supervisor of an owner of the door system (12),
a visual indication is displayed in a control interface for the automatic door system (12),
a maintenance instruction is sent to a technician of the owner or a manufacturer of the door system (12), and/or
a notification is sent to the manufacturer of the door system (12).

14. Detection unit for an automatic door system (12), wherein the detection unit (14) is configured to carry out a method according to claim 1.

15. System comprising the automatic door system (12) with the door (18), the at least one sensor (26), the control unit (22) configured to control the motion of the door (18), and a detection unit (14), wherein the system is configured to carry out the method according to claim 1.

16. A computer program product, embodied on a computer readable storage medium and configured so as when executed on a processor to perform operations of the method according to claim 1.
